(19) United States
(12) Patent Application Publication
(10) Pub. No.: US 2011/0191544 A1
(43) Pub. Date: Aug. 4, 2011

(54) Data Storage and Access

(75) Inventors: Harsha Sathyanarayana Naga, Southwark (GB); Neeraj Nayan, Southwark (GB)

(73) Assignee: NOKIA CORPORATION, Espoo (FI)

(21) Appl. No.: 12/989,536

(22) PCT Filed: Apr. 24, 2009
(86) PCT No.: PCT/IB09/05962

§ 371 Date: Feb. 3, 2011

(30) Foreign Application Priority Data
Apr. 24, 2008 (GB) 0807520.2

(51) Int. Cl. G06F 12/08

(52) U.S. Cl. 711/133; 711/118; 711/E12.017; 711/E12.022

(57) ABSTRACT

A data cache wherein contents of the cache are arranged and organised according to a hierarchy. When a member of a first hierarchy is accessed, all contents of that member are copied to the cache. The cache may be arranged according to folders which contain data or blocks of data. A process for caching data using such an arrangement is also provided for.

### TECHNICAL FIELD

This invention relates to the field of data storage and access. In particular, this invention relates in embodiments to the field of data caches and the structure and access of data stored in data caches.

### BACKGROUND TO THE INVENTION

Memory, disk input/output and microprocessor caches are known and are used to improve the speeds with which data and instructions are accessed and manipulated. Certain caches operate by copying data or instructions to a type of memory which is smaller, but quicker than the storage medium generally used. Other caches such as web caches operate by locating data in a more quickly accessible location compared to the normal location of that data. For example, a web proxy server may keep a record of those web pages frequently accessed and copy those pages to local storage. When a client of the proxy server accesses those pages, the proxy server will supply a copy of the locally stored pages, which can be substantially quicker than accessing the pages at their remote location.

The Windows XP operating system comes bundled with an application known as Prefetch. Prefetch monitors those applications and files accessed during boot up of a system and will attempt to load those applications and files into memory before the boot up process initiates with a view to speeding up the boot process. Prefetch operates regardless of the relations between the applications and files, relying instead on an indication of whether they are accessed during a boot procedure to determine whether they should be loaded into memory.

### SUMMARY OF THE INVENTION

According to a first embodiment, the invention provides for a method comprising:
(i) identifying a cache object to be included in a cache, the cache object being stored on a storage medium;
(ii) identifying at least one child object related to the cache object; and
(iii) on inclusion of the cache object in the cache, including at least one of the identified child objects in the cache.

Including said cache object in said cache may include including each of the identified child objects in the cache.

The method according to this embodiment of the invention first identifies the child object related to the cache object and then populates the cache by including the cache object and the child object in the cache. This can ensure that related objects will be included in the cache and appropriate measures may be taken if there is insufficient space in the cache to accommodate both the cache object and the child object.

A cache according to this embodiment of the invention is capable of being accessed and managed according to related child objects and therefore may provide significantly improved performance when utilised by a program which addresses the cache and child objects in accordance with the manner in which they are related. Furthermore, by utilising child and cache objects which are related, management operations such as population of the cache and deletion of objects stored in the cache can be carried out in bulk, which is more efficient and quicker than having to do so on a piecemeal basis.

The cache object and the child object may be related by means of a hierarchy. The hierarchy may be many-layered, with cache objects of one layer being child objects of another layer. The human relationship terms “parent”, “child” and “grandchild” are used herein to describe the manner in which various objects stored in the cache are related to one another. It is to be realised however, that the parent of one object may itself be the child of another object, depending on the nature of the actual objects involved.

The cache object may be a holder for the child objects.

The cache object may comprise one or more of the child objects. For example, the cache object may be a folder and the child objects may be items contained within the folder.

The child object may comprise one or more related grandchildren objects. For example, the cache object may correspond to a service, the child object may correspond to a folder, and the grandchildren objects may correspond to messages stored in a folder.

Said relations may be defined by a client application or by a data structure, or both.

The method may further comprise the steps of:
deleting objects from the cache according to a cache management policy; and
on deleting a cache object from the cache, deleting each child object related to the cache object.

Bulk removal of objects stored in the cache ensures that the objects which are stored in the cache remain relevant with reference to the manner in which they are related and therefore the cache may continue to be utilised by an application which addresses the objects in accordance with the manner in which they are related. As noted, bulk removal of objects can be more efficient than the piecemeal removal of objects stored by the cache.

The cache may include more than one child object related to the cache object and the child objects may be arranged according to blocks, each of the blocks having a fixed address range.

Arranging the contents of the cache according to blocks helps ensure that the contents may be easily addressed and managed.

The relation between the child object and the related cache object may be established by a software application. In this instance the relation may have a contextual significance for the software application and management of the cache according to these relations may ensure that the application operates in a more efficient and quicker manner.

The software application may utilise a database, and the cache object may be a database table and the child object, a database table entry.

The software application may involve sending, receiving and editing messages, and the cache objects may comprise message folders and the child objects may comprise message data. The software application may be a messaging application running on a mobile computing device.

Identifying a cache object to be included in the cache may comprise recording the access of a folder by a user of the software application. When the cache object is accessed by the application, all of the related child objects may be saved to the cache thereby speeding up the performance of the application when the thus stored child objects are accessed or manipulated.

The child objects may be stored on the storage medium, the storage medium being associated with a data store.

The storage medium may be distinguished from the cache medium by one or more of the following: the cache medium has a faster access time than the storage medium, the cache medium has a faster data read time than the storage medium, or the cache medium has a faster data write time than the storage medium. A cache medium which may be accessed, read from or written to faster than the storage medium used for general storage of data ensures that the operation of an application using the method described above may be quicker than the operation of the same application not using the aforementioned method.

The cache medium and the storage medium may be contained within the same device.

The method may further comprise:
identifying an amount of free space in the cache prior to the step of including the cache object and the child object in the cache;
on determining that there is insufficient space in the cache, identifying a replaceable cache object and deleting one or more child objects associated with the replaceable cache object and/or the replaceable cache object from the cache; and
thereafter, including the cache object and the child object in the cache.

The bulk deletion of related objects stored in the cache ensures that the cache can be managed according to the aforementioned relations between the data and child objects.

The replaceable cache object may be identified on the basis of a frequency at which cache objects are accessed.

The replaceable cache object may be identified as the object which has been least recently used among all objects of the cache.

The data cache may comprise at least one cache object and at least one child object wherein the child object is related to the cache object and wherein the cache includes an indication of the relation.

According to a further embodiment, the invention provides for a method comprising:
(i) identifying a cache object to be deleted from a cache;
(ii) identifying at least one child object related to said cache object; and
(iii) on deletion of said cache object in said cache, deleting one or more of said identified child objects from said cache.

According to a further embodiment, the invention provides for a cache which includes an indication of the relation between its members wherein the cache is adapted to be populated and managed with reference to the relations. Such a cache may be capable of providing enhanced access to the data stored in the cache.

The data cache may further comprise a list of all cache objects contained within the cache.

The list may be ordered according to a frequency at which the cache objects are accessed. This can assist in quickly identifying members of the cache according to a frequency with which the members are accessed.

The child objects may be arranged in blocks, each of the blocks having a predetermined address range. Each block corresponding to a child object may have the same sized address range.

The indication of the relation between the cache object and the child object may comprise a table associated with the cache object, the table comprising entries for each child object related to the cache object.

The storage medium and the cache medium may be contained within a single device.

According to a further embodiment, the invention provides for apparatus comprising a data cache as hereinbefore described. The apparatus may in some embodiments be a mobile computing device.

According to a further embodiment, the invention provides for a data cache comprising a plurality of cache objects, a subset of the cache objects being related to one another, the cache being adapted to store, delete or replace the subset of the cache objects, wherein the subset comprises more than one cache object and wherein all members of the subset are related to one another.

The cache objects of the subset may be related to one another by being child objects of the same parent object.

According to a further embodiment, the invention relates to a plurality of software applications arranged to provide an operating system, said operating system comprising a data cache as herein described.

According to a further embodiment, the invention relates to a recordable medium for storing program instructions, said instructions being adapted to provide a data cache as herein described. Embodiments of the invention may extend to any software, individual computer program, group of computer programs, computer program product or computer readable medium configured to carry out the methods set out above.

### BRIEF DESCRIPTION OF THE DRAWINGS

Embodiments of the invention are hereinafter described with reference to the accompanying diagrams where:

FIG. 1 is a schematic diagram of a mobile computing device in which an embodiment of the invention has been implemented;

FIG. 2 is a block diagram representing a portion of the mobile computing device of FIG. 1;

FIG. 3 is a view of the display of the mobile computing device of FIG. 1 while operating a messaging application;

FIG. 4 is a schematic block diagram of a portion of a message store of the mobile computing device of FIG. 1;

FIG. 5 illustrates a portion of the message store of FIG. 4;

FIG. 6 illustrates a structured list of folders of the portion of the message store of FIG. 5;

FIG. 7 illustrates a schema for constructing a cache according to an embodiment of the invention;

FIG. 8 illustrates an index table of a cache of an embodiment of the invention; and

FIG. 9 is a block diagram illustrating the operation of a method of managing a data cache of an embodiment of the invention.

### DESCRIPTION OF PREFERRED EMBODIMENTS

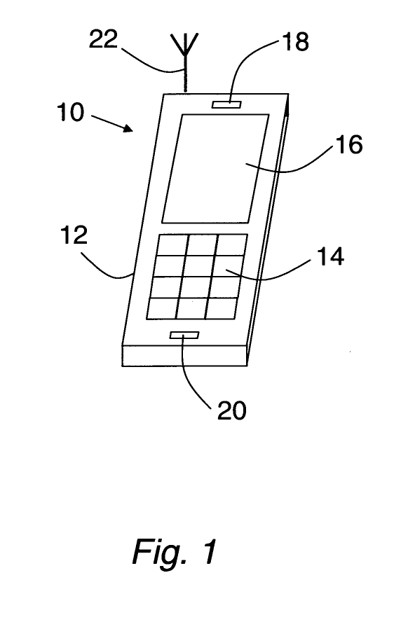

FIG. 1 is a schematic diagram of a mobile computing device 10 having a casing 12. The casing 12 encapsulates a keypad 14, a screen 16, a speaker 18 and a microphone 20. The device 10 further includes an antenna 22. The mobile computing device 10 illustrated in FIG. 1 may function as a phone and, in this instance, sends and receives telecommunication signals via antenna 22.

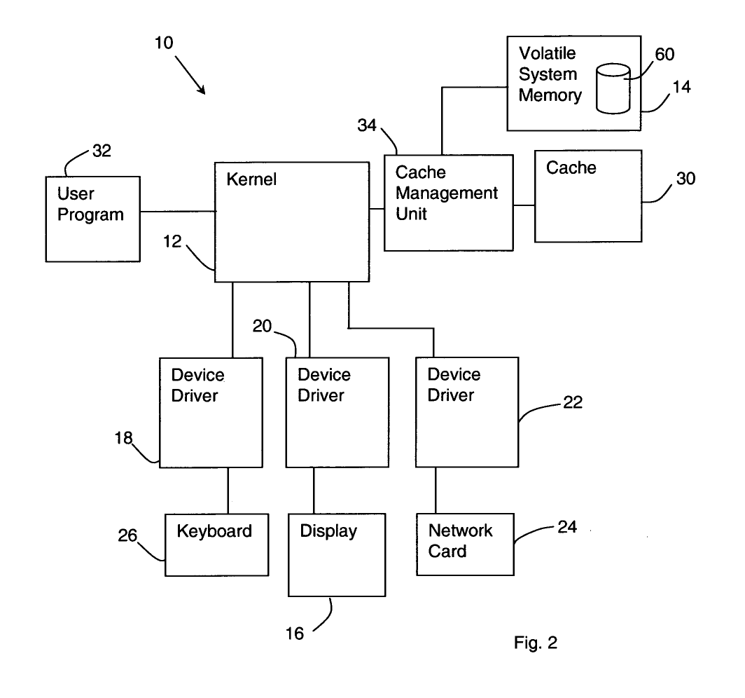

FIG. 2 is a schematic illustration of certain components of the mobile computing device 10. Device 10 includes a kernel 12 which represents the operating system of the device 10. In the embodiment shown, the operating system is the Symbian operating system. The invention is not however limited in this respect. The kernel 12 is connected to a volatile system memory 14 which is controlled by means of a cache management unit 34. Device drivers 18, 20 and 22 are connected to the kernel 12 and control the behaviour of, and communication with, respective devices: keyboard 26, display 16 and network card 24. It is to be realised that the mobile computing device 10 includes many more devices and components than those illustrated here. Mobile computing devices are known in the art and will therefore not be further described herein.

Mobile computing device 10 further comprises a memory cache 30 connected to the cache management unit 34.

In FIG. 2, the cache management unit 34 has been illustrated as a component distinct from the kernel 12, the memory 14, and the cache 30. In other embodiments, the cache management unit may be incorporated into any one of the kernel 12, the memory 14, the cache 30, or reside elsewhere. It will be realised that the embodiments of the invention described below will operate independently of where the cache management unit resides. It is further possible for the functions of the cache management unit 34 described herein to be performed by components of the mobile computing device other than a dedicated component e.g by the kernel 12.

The memory 14 is a volatile system memory of a known type. Similarly, the construction of the cache 30 is known. Of importance to the principles of the invention discussed below, the cache memory is generally smaller, but quicker, than the system memory 14. The cache 30 is smaller than system memory 14 in that it is capable of storing less data, but is quicker in that the mobile computing device is able to more quickly write, find and erase data on the cache 30 than on the system memory 14. It will be realised therefore that the physical components corresponding to the symbolic components of the cache 30 (a cache storage medium) and the system memory 14 (a storage medium) illustrated in FIG. 1 will differ according to the aforementioned size and capacity characteristics. Furthermore, the manner in which the invention operates as described below is equally applicable to a system where the cache management unit manages a hard disk drive which is used as the system memory and a volatile memory which is used as the cache (and may be implemented in a computing device which is not necessarily mobile).

Mobile computing device 10 further comprises a number of user software applications which allow a user to control the attached devices such as display 16. One of the software applications, a messaging program 32, is shown in FIG. 2. The messaging program 32 accesses a message store 60 stored in system memory 14 by means of the kernel 12 and the cache management unit 34.

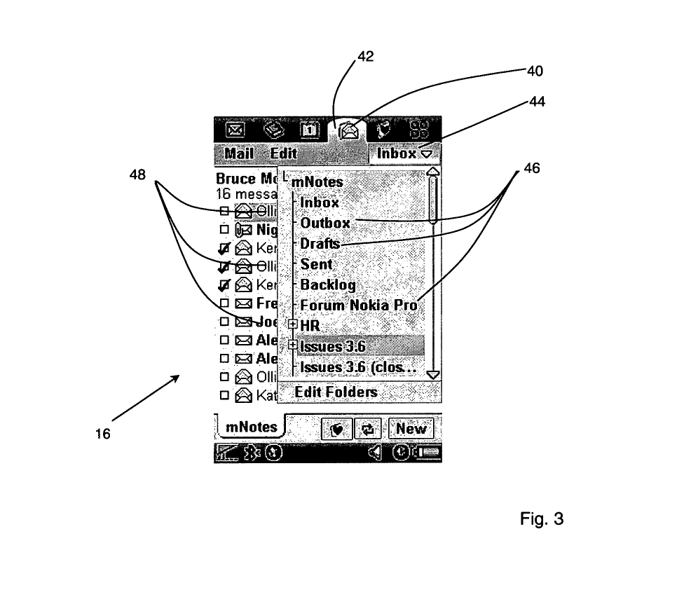

FIG. 3 illustrates the display 16 of the mobile computing device 10 when the messaging program 32 is being operated by a user. Icon 40 at the top of the display corresponds to the messaging program 32. The highlighted portion 42 surrounding icon 40 indicates that the messaging program is active and that the information displayed on display 16 corresponds to the operation of the messaging program 32. The upper-right portion of the display 16 shows a label 44 marked “Inbox” with a downward pointing arrow disposed next to the label. This indicates that the Inbox folder is currently selected. It is possible for the user to select alternative folders 46, as illustrated in the right-hand portion of the display 16 of FIG. 3.

On the left-hand side of display 16 a list of messages 48 is displayed, partially obscured by the list of folders 46, as illustrated. The messages 46 are those contained within the currently-selected folder, which is the inbox 44 here.

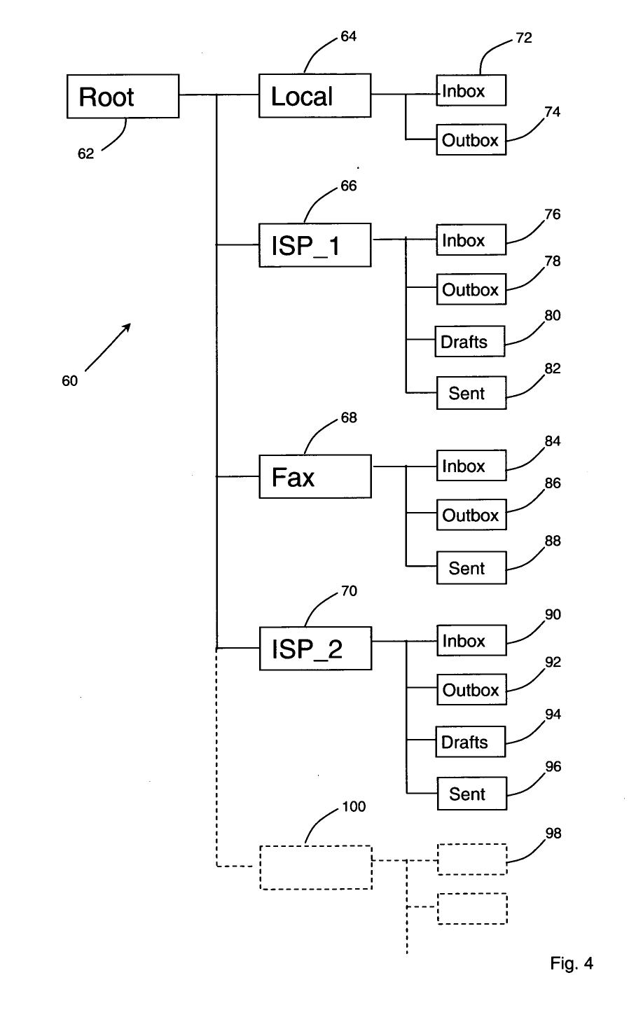

FIG. 4 illustrates a portion of the message store 60 accessed by the messaging program 32. As illustrated, the data of the message store is stored in a hierarchical arrangement. The top-most level of the hierarchy is represented by the root folder 62. Root folder 62 is divided into a number of second-tier folders: Local 64, ISP_1 66, Fax 68 and ISP_2 70. The message store 60 includes further second tier folders as illustrated by the folder 100 in dotted outline. Each of the second tier folders represents a service. Therefore, folder Local 64 represents the local messages, folder 66 represents all of the messages for an email account with the internet service provider ISP_1. In the embodiment illustrated, the message store 60 further stores messages for a fax service (folder 68) and for a second email account at an internet service provider (ISP_2, folder 70). Further folders for further services such as multimedia message service (MMS), short message service (SMS) may be provided, as represented by folder 100 in dotted outline.

Each of the folders of the second tier act as containers for folders of the third tier. Folders of the third tier include Inbox folders 72, 76, 84 and 90; Outbox folders 74, 78, 86 and 92; Drafts folders 80 and 94; and Sent folders 82, 88 and 96. Each of these folders correspond to a higher-level service folder, as illustrated in FIG. 4. Certain services require certain folders and therefore, for example, the email services represented by folders 66 and 70 require Inbox 76, 90, Outbox 78, 92, Sent 82, 96 and Draft 80, 94 folders, whereas the fax service requires Inbox 84, Outbox 86 and Sent 88 folders.

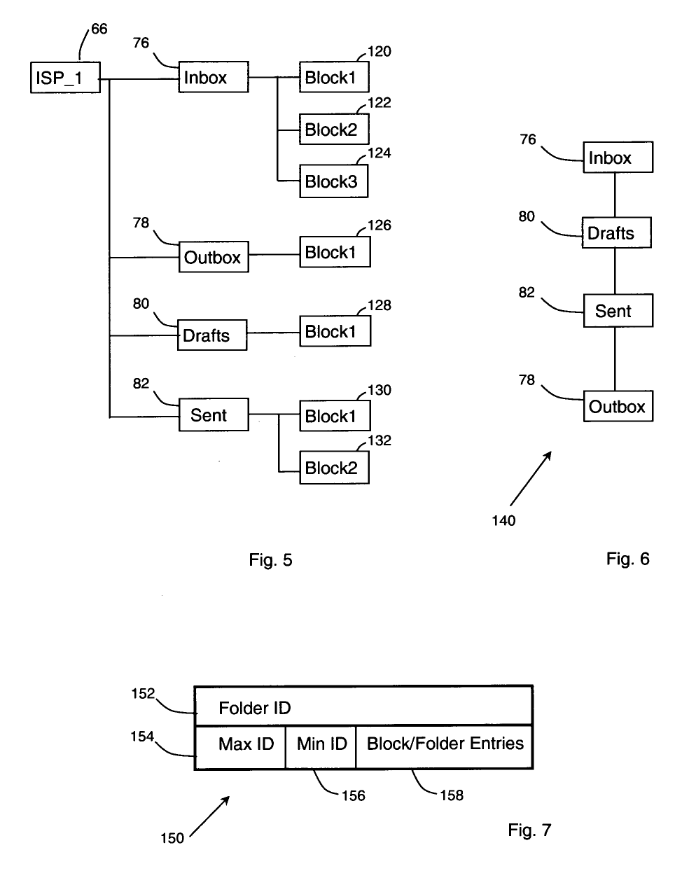

FIG. 5 illustrates a portion of the message store 60 illustrated in FIG. 4. FIG. 5 illustrates the Inbox 76, Outbox 78, Drafts 80 and Sent 82 folders of the email service of the ISP_1 folder 66 illustrated in FIG. 4. The message store 60 (FIG. 2) is comprised of a number of message “entries”. Each message entry will correspond to a particular folder and may correspond to a message. Messages include headers, bodies and may have other data such as attachments. Therefore the message entries will correspond to this data, which can vary substantially in size. To ensure that the cache 30 is easily managed, the data of the message entries are arranged into blocks on the level of the folder. Each block will have the same maximum size, and therefore serves as a placeholder for the message data in the cache.

As illustrated, each of the folders 76, 78, 80 and 82 stores message entries arranged into blocks. Therefore Inbox 76 has blocks 120, 122 and 124; Outbox 78 has block 126; Drafts 80 has block 128; and Sent 82 has blocks 130 and 132. The blocks of FIG. 5 each represent the same maximum amount of message data and are used to simplify cache and memory management, as described hereinafter. Folders and their corresponding message entries have been referred to herein by specifying that the folder “contains” the message entries and the message entries constitute the “contents” of the folders. It will be realised however that these relationships are defined by the relevant application (in this case, the messaging application). When stored in the message store 60, a folder entry is data describing that folder and a collection of pointers to the message entries of the messages designated as belonging to that folder.

In the embodiment illustrated, each of the blocks represents at most 64K of message data. It is to be realised however that the maximum size of the blocks may vary and will depend on the size of the cache 30, the speed with which the blocks may be written and accessed and the total size of the message store 60. The maximum size of the message blocks will be set when the message store 60 is initially created. Furthermore, each folder will not contain the same amount of data and therefore, although the blocks will have the same maximum size, but the last block of a folder will often be smaller than the predetermined maximum size.

FIG. 6 shows structured list 140 of folders of the ISP_1 service folder 66 of the message store of FIG. 5. The list 140 is arranged according to how often and how recently the folders have been accessed. The cache management unit 34 keeps track of how often each of the folders in the list 140 are accessed and therefore, the list 140 resides in the cache management unit 34. When a folder is accessed in the cache 30, the cache management unit 34 increments a corresponding entry in a local table corresponding to that folder. After each cache entry access, the cache management unit compares the number of times that each folder has been accessed and arranges the list 140 accordingly. Therefore, the list 140 represents the folders of the portion of the data store of FIG. 5 in decreasing order of number of access times. In the list illustrated in FIG. 6, the number of times the folders have been accessed is, in decreasing order: Inbox 76, Drafts 80, Sent 82 and Outbox 78.

FIG. 7 illustrates a schema for an index table of the cache 30. The index table comprises a plurality of entries 150. Each entry 150 includes a pointer to the name of the parent folder 152 and a row 154 for each block of the folder 152. Each row comprises a pointer to the Max ID 154, the Min ID 156 and the corresponding entries 158 of that block. Therefore each row relates to a block of message data identified by the minimum and maximum identity numbers of the message data entries in the message store 60. Message entries are numbered according to their creation date and therefore the entries of each row of the index table will be ordered by creation date in the table.

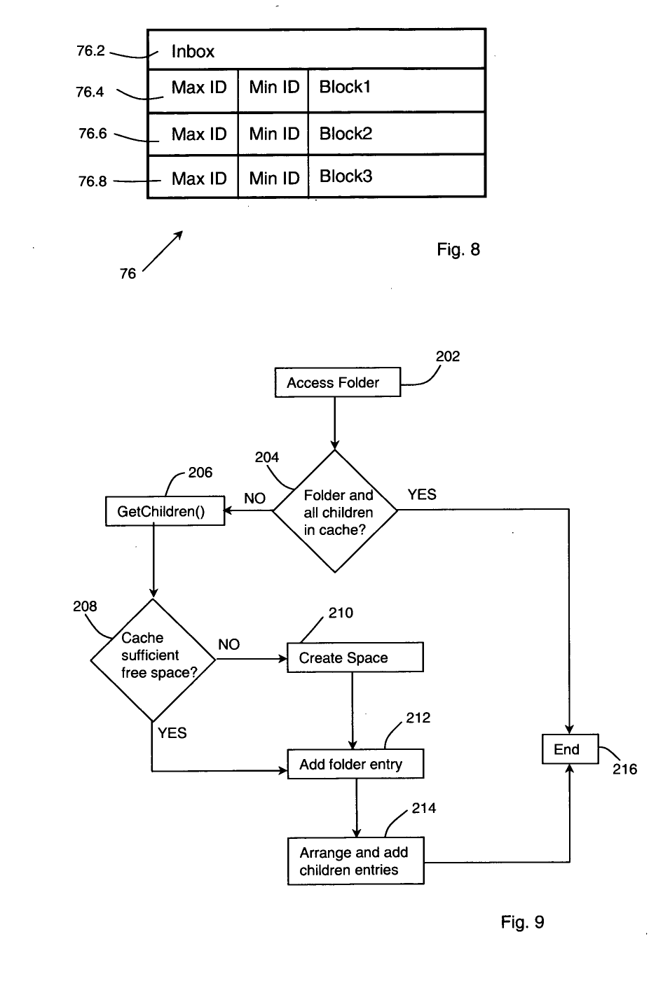

FIG. 8 illustrates the schema of FIG. 7 applied to the Inbox folder 76 of FIG. 5 and corresponds to an entry in the message cache 30. The cache entry 76 comprises the name of the parent object 76.2, here the label “Inbox”, and a plurality of rows, each row corresponding to a block of data. Therefore Block 1 has entries in row 76.4. Block2 entries in row 76.6 and Block3 entries in row 76.8. In this example, the Inbox has three blocks of data. However, it is only necessary to use more than one block of data for a particular folder where the size of the parent folder exceeds a predetermined size. In this embodiment, the blocks have a size of 64 kilobytes. Therefore, for any particular folder, only if the sum of the sizes of the entries of the children of the folder exceeds 64 kilobytes will more than one block be needed to represent the contents of that folder in the cache.

The cache 30 comprises a plurality of index tables according to the schema illustrated in FIG. 7 (each index table corresponding to a folder of the message store 60). Where the contents of a folder exceeds 64 kilobytes, the contents of that folder will span more than one block. Blocks are numbered and stored according to their date of creation. In the embodiment shown, blocks are added to and deleted from the cache according to their numbering (i.e. according to their creation date). Therefore, the cache includes members which are arranged according to the number of times they have been accessed (i.e. the folders) and members arranged according to their creation date (the blocks). In an alternative arrangement, the aforementioned table maintained by the cache manager further maintains a record of the number of times each block is accessed and the cache is managed by deleting the least frequently accessed blocks.

FIG. 9 is a process diagram illustrating the operation of a method of managing a data cache of a preferred embodiment of the invention. In block 202 the cache management unit records an access of a folder, and all blocks of the contents of that folder, if applicable. This corresponds to a user using the messaging program 32 to select one of the folders 46 illustrated in FIG. 3. As part of this step, the list 140 of the cache management unit 34 will be updated to reflect access of that folder.

The process will then proceed to block 204 where the cache management unit 34 determines whether the accessed folder and the contents of the accessed folder are in the cache. If the folder and its contents are in cache, the process will terminate at block 216.

However, if the folder and its contents are not in the cache, the process will proceed to block 206 where the contents of the folder are retrieved using the GetChildren( ) function. As part of this retrieval, the cache management unit 34 will determine the space needed to store the folder and its contents. In a procedure not illustrated in FIG. 9, if the size of the folder and its contents exceeds the size of the cache, the process will terminate with an error.

At the following block, block 208, the cache management unit 34 will determine whether sufficient space exists in the cache to store the folder and its contents. If sufficient space does exist, the process proceeds to block 212 where the folder is added to the cache by reading the relevant data from the memory where it is stored and writing this data to the cache 30. At the same time the index table for that folder will be created if not previously created and pointers to the block or blocks for the content of the folder written to the index block.

If there is insufficient space in the cache, the process proceeds to block 210 where sufficient space is created in the cache to accommodate the accessed folder and its contents. As described above with reference to FIG. 6, a list 140 is maintained indicative of the number of times the folders in the cache 30 are accessed. Therefore, if additional space is required in the cache, the cache management unit 34 will delete the contents of the least accessed folder (determined with reference to list 140) from the cache. If this provides insufficient space for the contents of the accessed folder, the second least accessed folder is deleted and so forth, until sufficient space exists in the cache 30. With reference to FIG. 7, a folder is deleted by removing the pointers to the entries of all of the blocks of that folder (i.e. portion 158 of the index table 150 is rendered null for all rows). If any of the contents of the folder designated for deletion cannot be deleted as this contents has been locked for use by another application, the cache management unit 34 will delete that portion of the contents of the folder not locked. In this scenario, the cache will store a portion of the folder designated for deletion from the cache.

If, at block 208 it is determined that sufficient space exists in the cache, or once sufficient space has been created by the deletion of cache entries in block 210, the process will proceed to block 212 where the folder and its contents are added to the cache. The data of the block or blocks of the folder are written to the cache and an index table for that cache is created or updated. The process will then terminate at block 216. In an alternate embodiment, if the available space in the cache is smaller than the size of the folder to be cached, the cache management unit will write as much of the contents of the folder as will fit into the available cache. In this instance the cache is populated by the contents of the folder according to a creating date of the blocks of the folder (as this is the order in which the blocks are stored).

Once the cache 30 has been populated in the manner specified, it is accessed in a known manner. For example, when the folder is accessed (in block 202 of the process of FIG. 9), the contents of the accessed folder are read from the cache and organised into a list where the list is specified by the client application. The list is then sorted according to criteria specified by the client application. For example, the client application may request a list of all of the headers of the messages of the Inbox 76 sorted according to the date received. The blocks, Block1 120, Block2 122 and Block3 124 (FIG. 5) are then read from the memory and those message entries in these blocks corresponding to message headers are compiled into a list. The list is then sorted according to date received.

In the aforementioned embodiment, space is created in the cache by deleting folders according to how often they have been accessed. Other criteria for identifying replaceable cache objects are known in the art such as most recently used (MRU), pseudo least recently used (PLRU), least frequently used (LFU) etc. and any one of the known algorithms may be used with caches according to embodiments of the invention.

It will seen then that the cache 30 is organised and arranged according to hierarchies defined by the user application such as the messaging program 32 discussed above. So, once the Inbox (or any other folder) of this application has been accessed, the contents of the Inbox may be copied to the cache and each of the entries so copied will be more easily and quickly accessible than if they had been stored in the volatile system memory 14.

Furthermore, as the cache 30 comprises a cache object such as a folder and the contents of the folder such as a block of messages, when an application accesses the cache object, child objects (blocks) of that cache object will have been written to the cache. Therefore access to those child objects will be significantly quicker than if the child objects had to be retrieved from a storage location which does not operate as a cache.

It is to be realised that although the invention has been described with reference to message store 60 and message program 32, it may be applied to any relational data accessed in terms of the relations. For example, the invention may be applied to databases where data is stored as tables or binary trees. Furthermore, it is not necessary that the relations be defined by a user application. An application which, for example, writes the data to a storage device may define the relations. Furthermore, the relations may be defined by the data store, in which case the user application is written to utilize the predefined structure including the hierarchies. However, in this case, it is to be realised that hierarchies between data entries is defined by the application in as much as the user uses the application to, for example, file a message in a selected folder. The aforementioned embodiments apply to the folder and message hierarchies of the message store 60. It is to be realised however that a cache may be implemented for the service and folder level instead, in the situation where this is required. Similarly, a cache such as that described above may be implemented for any other data where the corresponding data includes a indication of the hierarchy of the data.

1. A method comprising:
(i) identifying a cache object to be included in a cache, said cache object being stored on a storage medium;
(ii) identifying at least one child object related to said cache object; and
(iii) on inclusion of said cache object in said cache, including one or more of said identified child objects in said cache in an order according to criteria specified by a client application.

2-32. (canceled)

33. The method of claim 1, comprising one or more of:
including said child objects in said cache in order of creation date; and
including said cache objects in said cache in order of a number of times they have been accessed.

34. The method of claim 1, comprising:
including more than one child object related to said cache object in said cache, and arranging said child objects in blocks.

35. The method of claim 34, wherein at least one of said blocks has a fixed address range.

36. The method of claim 1, comprising:
including an indication of a relation between said cache object and one or more of said identified child objects in said cache;
wherein the indication of the relation between the cache object and the child object comprises a table associated with the cache object, the table comprising entries for at least one child object related to the cache object.

37. The method of claim 36, further comprising populating and managing the cache with reference to the relation.

38. The method of claim 1, comprising:
maintaining a list of cache objects contained within the cache.

39. The method of claim 38, wherein said list is ordered according to at least one of:
a frequency at which said cache objects are accessed; and
how recently the cache objects have been used.

40. The method of claim 1, comprising:
identifying an amount of free space in the cache prior to including the cache object and the child object in the cache;
on determining that there is insufficient space in the cache, identifying a replaceable cache object and deleting one or more child objects associated with the replaceable cache object and/or the replaceable cache object from the cache; and
thereafter, including the cache object and the child object in the cache.

41. The method of claim 40, comprising at least one of:
identifying said replaceable cache object on the basis of a frequency at which cache objects are accessed; and
identifying said replaceable cache object as the object which has been least recently used among all objects of the cache.

42. The method of claim 40, wherein if any of the replaceable cache objects cannot be deleted as their contents have been locked for use by another application, then the method comprises deleting that portion of the replaceable cache object that is not locked.

43. The method according to claim 1 wherein said cache object is a holder for said child objects.

44. The method according to claim 1 wherein said child object comprises one or more related grandchildren objects.

45. The method according to claim 1 wherein the relation between said child object and said related cache object is established by a software application, and wherein said software application is configured to send, receive and edit messages, and wherein said cache objects comprise message folders and said child objects comprise message data.

46. The method according to claim 1 wherein identifying a cache object to be included in the cache comprises recording the access of a folder by a user of the software application.

47. A data cache for storing a plurality of objects, said data cache comprising at least one cache object and at least one child object wherein said child object is related to said cache object and wherein said cache includes an indication of said relation; wherein said child objects are included in said cache in an order according to criteria specified by a client application.

48. Apparatus comprising a data cache according to claim 47.

49. A data cache comprising a plurality of cache objects, a subset of said cache objects being related to one another, said cache being adapted to store, delete or replace said subset of said cache objects, wherein said subset comprises more than one cache object and wherein all members of said subset are related to one another; wherein said subset of said cache objects child objects are included in said data cache in an order according to criteria specified by a client application.

50. Apparatus comprising a data cache according to claim 49.

51. A recordable medium for storing program instructions, said instructions being adapted to provide a data cache according to claim 47 or claim 49.
